(19) United States
(12) Patent Application Publication
(10) Pub. No.: US 2010/0224124 A1
(43) Pub. Date: Sep. 9, 2010

(54) VEHICLE MASKING COVER

(75) Inventor: Steven Derek Bush, Western Australia (AU)

Correspondence Address: JAMES D. STEVENS;REISING ETHINGTON P.C., P.O. BOX 4390, TROY, MI, 48099, US

(73) Assignee: ZIPPMASK.COM PTY LTD, Claremont North (AU)

(21) Appl. No.: 12/594,322

(22) PCT Filed: Sep. 5, 2007
(86) PCT No.: PCT/AU07/01295

§ 371 Date: Apr. 29, 2010

(30) Foreign Application Priority Data
Apr. 2, 2007 (AU) 2007901746

(51) Int. Cl. B05C 21/00; B60J 11/00

(52) U.S. Cl. 118/504

(57) ABSTRACT

A vehicle masking cover (10) for protecting external areas of a vehicle (100) from overspray during a refinishing process, comprising a plurality of panel sections (20), each panel section being provided with a fastening means (96, 98) which detachably interconnects with the fastening means (96, 98) of an adjacent panel section to form a sealed seam. The arrangement is such that a portion of a panel section (20) is folded back from the vehicle masking cover (10) to expose an external area of the vehicle (100) to be refinished while the external area of the vehicle (100) underneath the interconnected panel sections (20) of the vehicle masking cover (10) is protected from overspray, the folded panel section (20) remaining attached to the vehicle masking cover (10) at a portion of the folded panel section (20).

### FIELD OF THE INVENTION

The present invention relates to a vehicle masking cover for protecting external areas of a vehicle from overspray during a refinishing process.

### SUMMARY OF THE INVENTION

In accordance with a first aspect of the present invention there is provided a vehicle masking cover for protecting external areas of a vehicle from overspray during a refinishing process, characterized by comprising a plurality of panel sections, each panel section being provided with a fastening means which detachably interconnects with the fastening means of an adjacent panel section to form a sealed seam, the arrangement being such that in use a portion of a panel section is folded back from the vehicle masking cover to expose an external area of the vehicle to be refinished while the external area of the vehicle underneath the interconnected panel sections of the vehicle masking cover is protected from overspray, the folded panel section remaining attached to the vehicle masking cover at a portion of the folded panel section.

### BRIEF DESCRIPTION OF THE DRAWINGS

The present invention will now be described, by way of example, with reference to the accompanying drawings, in which:

FIG. 1 is a perspective view of the vehicle masking cover draped over a vehicle whose external surfaces require protection from overspray during a refinishing process in accordance with the present invention; and

FIG. 2 is a plan view of the vehicle masking cover of FIG. 1 draped over a vehicle.

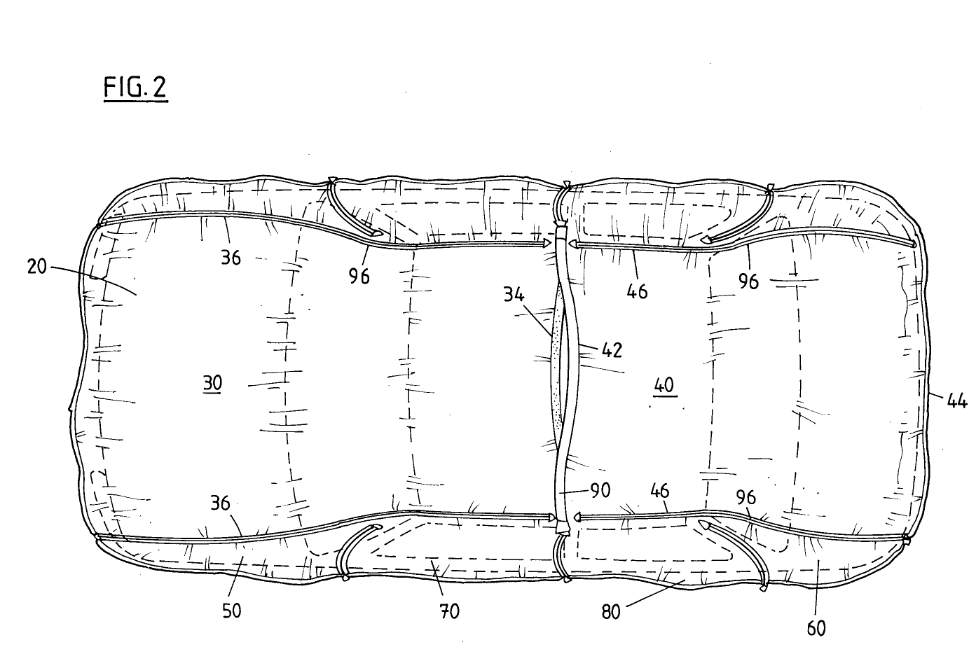

FIG. 3 is a perspective view of the vehicle masking cover of FIGS. 1 and 2 shown, in use, with folded panel sections remaining attached to the vehicle masking cover at one portion of the folded panel section in accordance with the present invention.

### DETAILED DESCRIPTION OF THE PREFERRED EMBODIMENT

Referring to the Figures, wherein like numerals and symbols refer to like parts throughout, there is shown a vehicle masking cover 10 for protecting external areas of a vehicle 100 from overspray during a refinishing process. The vehicle masking cover 10 comprises a plurality of panel sections 20, each panel section 20 substantially corresponding in shape and area to a portion 120 of external area specific to the vehicle 100.

The vehicle 100 is any generally man-made means of transportation or carriage, such as but not limited to, bicycles, cars, trucks, motorcycles, trains, ships, aircraft, trailers and caravans.

The panel sections 20 include a forward panel section 30, a rear panel section 40, two opposing forward flank panel sections 50, two opposing rear flank panel sections 60, two opposing forward side panel sections 70, and two opposing rear side panel sections 80. The forward panel section 30 has a forward edge 32, a rear edge 34, and two opposing side edges 36. The rear panel section 40 has a forward edge 42, a rear edge 44, and two opposing side edges 46. The rear edge 34 of the forward panel section 30 and the forward edge 42 of the rear panel section 40 are each provided with a first fastening means 90 extending transversely along the whole length of each edge 34, 42. Preferably, the first fastening means 90 is a length of hook and loop fastening material, such as VELCRO™

The first fastening means 90 of each edge 34, 42 are arranged to conjoin detachably to each other to form a first fastened seam between the rear and front edges 34, 42 of the forward and rear panel sections 30, 40. The first fastened seam is sealed against penetration of spray paint such that the body panel of the vehicle 100 underneath the vehicle masking cover 10 is protected from overspray.

The side edges 36, 46 of the front and rear panel sections 30, 40 are each provided with a respective second fastening means 96 extending longitudinally along the length of each side edge 36, 46. Preferably, each second fastening means 96 is a double-ended zip-fastener.

Each forward flank panel section 50 has an outer edge 52, a forward edge 54, and a rear edge 56. Each rear flank panel section 60 has an outer edge 62, a forward edge 64, and a rear edge 66. The forward edge 54 of the forward flank panel section 50 and the rear edge 66 of the rear flank panel section 60 are each formed by a second fastening means 96 extending longitudinally along the length of each edge 54, 66. The rear edge 56 of the forward flank panel section 50 and the forward edge 64 of the rear flank panel section 60 are each provided with a third fastening means 98 extending transversely along the length of each edge 56, 64. Preferably, the third fastening means 98 are single ended zip fasteners.

The second fastening means 96 of each edge 54, 66 are arranged to detachably conjoin to the second fastening means 96 of respective side edges 36, 46 of the front and rear panel sections 30, 40 to form a second fastened seam between the forward panel section 30 and the forward flank panel section 50 and between the rear panel section 40 and the rear flank panel section 60.

Each forward side panel section 70 has an outer edge 72, an inner edge 74, a forward edge 76, and a rear edge 78. Each rear side panel section 80 has an outer edge 82, an inner edge 84, a forward edge 86, and a rear edge 88. The inner edges 74, 84 of the forward side panel section 70 and the rear side panel section 80 are each provided with a second fastening means 96 extending longitudinally along the length of each edge 74, 84. The forward and rear edges 76, 86, 78, 88 of the forward and rear side panel sections 70, 80 are each provided with a third fastening means 98 extending transversely along the length of each edge 76, 86, 78, 88.

The second fastening means 96 of each edge 74, 84 are arranged to conjoin detachably to the second fastening means 96 of respective side edges 36, 46 of the front and rear panel sections 30, 40 to form a second fastened seam 96 between the forward and rear panel sections 30, 40 and the forward and rear side panel sections 70, 80.

The third fastening means 98 of each rear edge 56 of the front flank panel sections 50 are arranged to conjoin detachably to the third fastening means 98 of respective forward edges 76 of the front side panel sections 70 to form a third fastened seam between the front flank panel sections 50 and the forward side panel sections 70. The third fastening means 98 of each rear edge 78 of the front side panel sections 70 are arranged to conjoin detachably to the third fastening means 98 of respective forward edges 86 of the rear side panel sections 80 to form a third fastened seam between the forward and rear side panel sections 70, 80. The third fastening means 98 of each rear edge 88 of the rear side panel sections 80 are arranged to detachably conjoin to the third fastening means 98 of respective forward edges 64 of the rear flank panel sections 60 to form a third fastened seam 99c between rear side panel sections 80 and the rear flank panel sections 60.

The second fastened seams and the third fastened seams are sealed against penetration of spray paint such that the body panel of the vehicle 100 underneath the vehicle masking cover 10 is protected from overspray. Preferably, each of the second and third fastening means 96, 98 are provided with a fabric overlay to cover the seam between respective panel sections. In other words, the second and third fastening means 96, 98 are preferably invisible zips.

As can be seen in the drawings, the third fastening means 98 of the panel sections 50, 60, 70 and 80 extend from the lower, outer edges of these panel sections towards the second fastening means 96. However, in each instance, the third fastening means 98 terminates short of the second fastening means 96. Thus, in each instance, there is a spacing 102 between an inner end of each third fastening means 98 and the adjacent second fastening means 96.

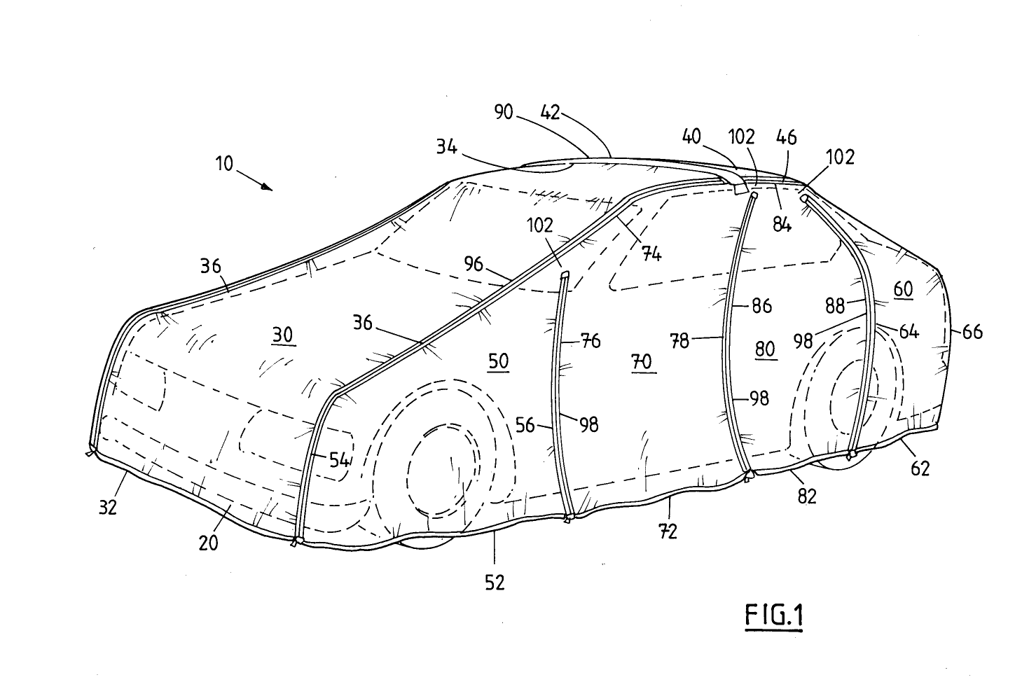

Further, the third fastening means 98 are preferably curved along their length as best seen in FIG. 1. This enables the flank panel sections 50, 60, 70 or 80 to conform more closely to the shape of a typical motor car 100.

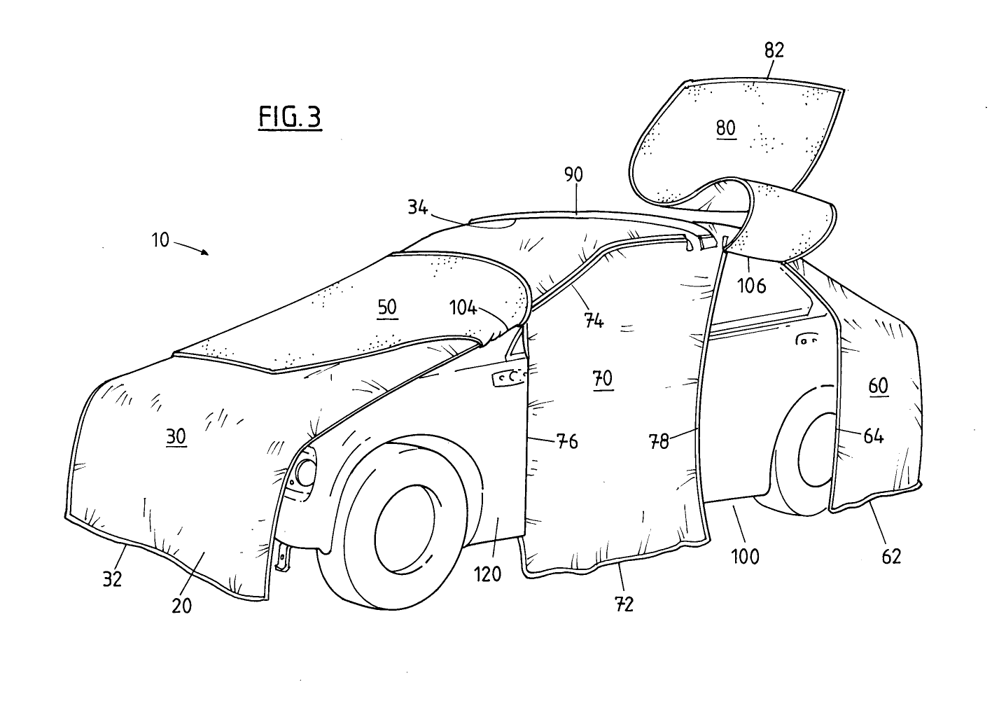

As can be seen in FIG. 3, the arrangement of the second and third fastening means 96, 98 is such that whilst the fastening means of one flank panel section 50, 60, 70 and 80 can be detached from the fastening means of an adjacent flank panel section along its length, thus enabling the panel section to be folded back to selectively expose a portion of the underlying vehicle 100 for refinishing, the folded flank panel section can never be completely detached from the vehicle masking cover 10 because of the spacing 102. The folded flank panel section is always attached to the vehicle masking cover 10 by a portion of the flank panel section. In particular, the flank panel section 50, as shown in FIG. 3, when folded back remains attached to the remainder of the cover 10 at one corner 104. Further, the flank panel section 80 remains attached to the cover 10 when folded back along a region 106 between the fastening means 98. In this way, the folded flank panel sections cannot be displaced or repositioned in an incorrect place in relation to the other panel sections as the flank panel sections are not completely detached from the vehicle masking cover 10 in the first place. The arrangement is particularly advantageous in terms of saving time and labour.

An exterior surface of the vehicle masking cover 10 is arranged to be formed from a fabric that is chemical-resistant, solvent-resistant, and non-porous. It is also desirable that the fabric has anti-static properties to repel dust and the fine paint droplets comprising overspray. The advantage afforded by an anti-static exterior surface is two-fold. Firstly, it is advantageous to maintain a clean working area during the refinishing process as dust can be deleterious to a freshly refinished surface, whilst overspray can spoil the original paintwork. Secondly, because the refinishing process is performed in a hazardous atmosphere heavily contaminated with volatile solvents, it is extremely important to minimize the risk of spark production and subsequent explosion. Furthermore, the ability to repel dust and overspray affords a vehicle masking cover that can be easily cleaned and reused. It is thus envisaged that the vehicle masking cover 10 will be recyclable.

Preferably, the exterior surface of the vehicle masking cover 10 is formed from a non-woven polyethylene coated fabric, such as TYVEC™ by Dupont™.

An interior surface of the vehicle masking cover 10 is arranged to be formed from a soft, fibrous material such that the surface of the vehicle 100 underlying the vehicle masking cover 10 is protected from scratching during the refinishing process.

In use, the vehicle masking cover 10 is fitted over the vehicle as shown in FIG. 1. Any particular panel section corresponding to a portion of the vehicle 100 which is arranged to undergo a refinishing process is folded back from the vehicle masking cover 10 by detaching the fastening means of the panel section from the fastening means of the adjacent panel sections. In this way the intended portion of the vehicle 100 is selectively exposed and can undergo the refinishing process whilst the remaining surface of the vehicle 100 is protected from overspray by the remaining panel sections of the vehicle masking cover 10. Conventional masking materials may be used to fine mask the edges of the vehicle masking cover 10 to minimize overspray onto the vehicle masking cover. After the refinishing process is completed the panel section is replaced in position in the vehicle masking cover 10.

The vehicle masking cover 10 can be reused on another vehicle 100 after the vehicle 100 has been completely refinished.

Modifications and variations as would be apparent to a skilled addressee are deemed to be within the scope of the present invention

1. A vehicle masking cover for protecting external areas of a vehicle from overspray during a refinishing process, characterized by comprising a plurality of panel sections, each panel section being provided with a fastening means which detachably interconnects with the fastening means of an adjacent panel section to form a sealed seam, the arrangement being such that in use a portion of a panel section is folded back from the vehicle masking cover to expose an external area of the vehicle to be refinished while the external area of the vehicle underneath the interconnected panel sections of the vehicle masking cover is protected from overspray, the folded panel section remaining attached to the vehicle masking cover at a portion of the folded panel section.

2. A vehicle masking cover according to claim 1, characterized in that a folded panel section remains attached to the vehicle masking cover at least one corner of the folded section.

3. A vehicle masking cover according to claim 1 or 2, characterized in that the cover comprises a longitudinal panel which extends from front to rear over a vehicle.

4. A vehicle masking cover according to claim 3, characterized in that the longitudinal panel section comprises a forward panel section and a rear panel section interconnected by first transversely extending fastening means.

5. A vehicle masking cover according to claim 3 or 4, characterized in that the vehicle masking cover comprises a plurality of flank panel sections which are interconnected by third transverse fastening means.

6. A vehicle masking cover according to claim 5, characterized in that the third transverse fastening means interconnects the flank panel sections from outer edges of the flank panel sections to a point adjacent to but spaced from the longitudinal fastening means such that the flank panel sections are not detached from the remainder of the cover in use.

7. A vehicle masking cover according to claim 5 or 6, characterized in that the flank panel sections are connected to the longitudinal panel section by second longitudinally extending fastening means.
